(19) United States
(12) Patent Application Publication
(10) Pub. No.: US 2024/0320234 A1
(43) Pub. Date: Sep. 26, 2024

(54) PREVIEW DATA LINEAGE RELATIONSHIP TO REDUCE ETL

(71) Applicant: International Business Machines Corporation, Armonk, NY (US)

(72) Inventors: Yi Yang Ren, Beijing (CN); Chun Hua Sun, Beijing (CN); Xu Bin Cai, Beijing (CN); Wei Wang, BEIJING (CN); Jian Ling Shi, Baoji (CN); Chun Leng, BeiJing (CN); Pin Lv, BeiJing (CN)

(21) Appl. No.: 18/125,882

(22) Filed: Mar. 24, 2023

(51) Int. Cl. G06F 16/25; G06F 16/215

(52) U.S. Cl. CPC G06F 16/254; G06F 16/215

(57) ABSTRACT

An approach is disclosed that receives a new ETL job. The job includes a number of intermediate database files descriptors corresponding to a plurality of intermediate database files that are used to accomplish the new ETL. A new data lineage graph is created that pertains to the new ETL job. The new data lineage graph is compared to a number of existing data lineage graphs with each of the existing data lineage graphs corresponding to an existing ETL job. The approach substitutes existing database files found in the existing data lineage graphs for one or more intermediate database files found in the new data lineage graph. The new ETL job is then run by utilizing the substituted database files, the result being a new final database file.

### BACKGROUND

ETL, which stands for “extract, transform and load,” is a data integration process that combines data from multiple data sources into a single, consistent data store that is loaded into a data warehouse or other target system. As databases grew in popularity in the 1970s, ETL was introduced as a process for integrating and loading data for computation and analysis, eventually becoming the primary method to process data for data warehousing projects. ETL provides the foundation for data analytics and machine learning workstreams. Through a series of business rules, ETL cleanses and organizes data in a way which addresses specific business intelligence needs, like monthly reporting, but it can also tackle more advanced analytics, which can improve back-end processes or end user experiences. ETL is often used by an organization to extract data from legacy systems, cleanse the data to improve data quality and establish consistency, and load data into a target database.

### SUMMARY

An approach is disclosed that receives a new ETL job. The job includes a number of intermediate database files descriptors corresponding to a plurality of intermediate database files that are used to accomplish the new ETL. A new data lineage graph is created that pertains to the new ETL job. The new data lineage graph is compared to a number of existing data lineage graphs with each of the existing data lineage graphs corresponding to an existing ETL job. The approach substitutes existing database files found in the existing data lineage graphs for one or more intermediate database files found in the new data lineage graph. The new ETL job is then run by utilizing the substituted database files, the result being a new final database file.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting components used in designing ETL (Extract-Transform-Load) processes using a sandbox environment;

FIG. 4 is a current ETL job lineage knowledge graph and a knowledge graph for a new ETL job that uses existing intermediate tables;

FIG. 5 is a flowchart depicting high-level steps used in an ETL development sandbox environment;

FIG. 6 is a flowchart depicting steps used to compare ETL knowledge graphs; and

FIG. 7 is a flowchart depicting steps used to test a new job by reusing identified portions of the ETL knowledge graph.

### DETAILED DESCRIPTION

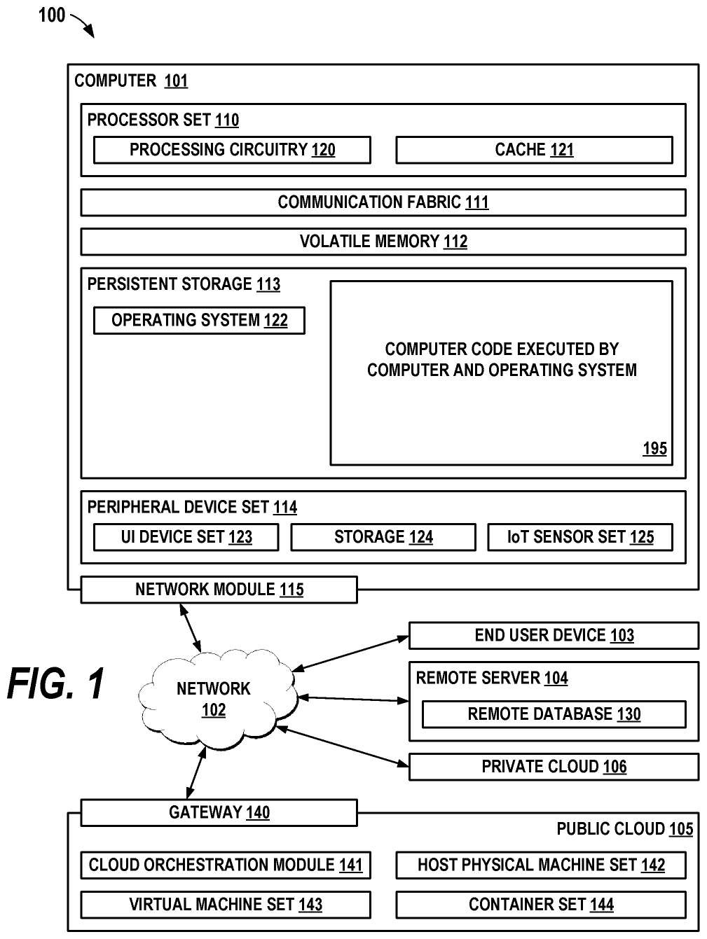

FIGS. 1-7 describe an approach that addresses issues related to bloated ETL (Extract-Transform-Load) processes and their intermediate tables that consume extensive information technology (IT) resources. The approach utilizes a novel “sandbox” environment to effectively reduce repetitive ETL operations.

In many organizations, a few thousand source tables can often multiply to many times that number, sometime over a million, intermediate tables stored in the system. In addition, there are numerous ETL processes (jobs) running, some of which are repetitive (redundant) jobs.

The following are data governance technologies that aid in making ETL more efficient. First, defining terms on data dictionary and display them on knowledge graph, especially the business index terms which can help unify the cognition of each department's business which can help reduce the duplicate assets and business tasks like ETL creation, execution, and reuse of exiting assets. Second, data quality governance, for example, auto discovery, understand data by data classes and assign terms on data assets. It can help understand data quality problems such as incomplete/inaccurate before cleaning the data by running ETL, and then users can use understandable high-quality data for running ETL to reduce the number of invalid ETL execution. Third, data lineage, it can help understand the data relationship of ETL in order to logically reduce unnecessary ETL intermediate tables and execution. Fourth, workflow management, through standardized workflow, enterprises can effectively manage assets before designing ETL jobs. Then some irregular and noneffective ETL can be reduced. Finally, fifth, data virtualization, federated database, can help reduce data copies by virtually connecting data end points and simplifying the access patterns over any data sources. Hence, system can access these data without running tons of ETL jobs.

The new method of running ETL jobs more efficiently includes the following. First, Save/Submit new developed ETL job A and its test data into a sandbox. Second, run this ETL job A in a sandbox by using its test data, then get its data lineage paths as “Version 2” (Note: the legacy lineage path is version 1 without running job A) in this sandbox of knowledge graph. Third, compare this developed ETL job's lineage paths (Version 2) with legacy data lineage paths (Version 1) in the sandbox's knowledge graph. Fourth, if the paths coincide, all the ETL jobs and datasets on legacy lineage path can be reused. If they do not coincide, the job paths of the parts that do not coincide can be prompted to the developers to split these ETL logic off to small ones and develop them to new small ETL jobs. And fifth, run these new developed small jobs and the chosen/re-used jobs from legacy lineage paths together by using orchestration pipeline which has the same business logic as job A.

The organization's process to make ETL jobs more efficient include using this new approach to preview data lineage in sandbox environment before submitting an ETL job to the production system. ETL tasks use sets of small jobs whenever possible to prevent duplicate ETL jobs. These small workflow/jobs replace large monolithic ETL jobs after previewing job lineage. Data freshness is verified and refreshed when needed to reuse intermediate legacy datasets on lineage path whenever possible to prevent bloated ETL and excessive intermediate tables in the organization's IT system.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

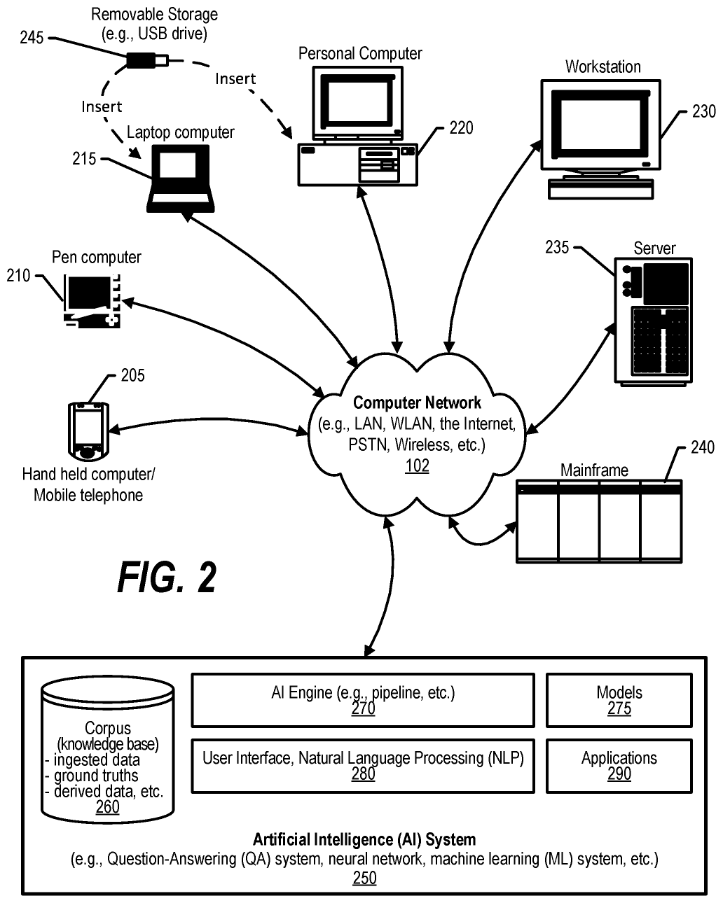

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 1 is a block diagram of a data processing system in which the methods described herein can be implemented. Computing environment 100 contains an example of an environment for the execution of at least some of the computer code 195, the operation and functionality of which being described herein. Computer code may include one or more blocks of computer code. In addition to computer code 195, computing environment 100 includes, for example, computer 101, computer network 102 (e.g., one or more Wide Area Networks (WANs), Local Area Networks (LANs), wireless networks, telephone networks including public switched telephone network (PSTN), the Internet, etc.), end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and computer code 195, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet.

In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A NETWORKED ENVIRONMENT is shown in FIG. 2. The networked environment provides an extension of the information handling system shown in FIG. 1 illustrating that the methods described herein can be performed on a wide variety of information handling systems that operate in a networked environment, depicted by computer network 200. Types of computer networks can include local area networks (LANs), wide area networks (WANs), the Internet, peer-to-peer networks, public switched telephone networks (PSTNs), wireless networks, etc. Types of information handling systems range from small handheld devices, such as handheld computer/mobile telephone 205 to large mainframe systems, such as mainframe computer 240. Examples of handheld computer 205 include smart phones, personal digital assistants (PDAs), personal entertainment devices, such as MP3 players, portable televisions, and compact disc players. Other examples of information handling systems include pen, or tablet, computer 210, laptop, or notebook, computer 215, personal computer 220, workstation 230, and server computer system 235. Other types of information handling systems that are not individually shown in FIG. 2 can also be interconnected other computer systems via computer network 200.

Many of the information handling systems include nonvolatile data stores, such as hard drives and/or nonvolatile memory depicted in FIG. 1. These nonvolatile data stores and/or memory can be included, or integrated, with a particular computer system or can be an external storage device, such as an external hard drive. In addition, removable nonvolatile storage device 245 can be shared among two or more information handling systems using various techniques, such as connecting the removable nonvolatile storage device 245 to a USB port or other connector of the information handling systems.

An ARTIFICIAL INTELLIGENCE (AI) SYSTEM is depicted at the bottom of FIG. 2. Artificial intelligence (AI) system 250 is shown connected to computer network 200 so that it is accessible by other computer systems 205 through 240. AI system 250 runs on one or more information handling systems (comprising one or more processors and one or more memories, and potentially any other computing device elements generally known in the art including buses, storage devices, communication interfaces, and the like) that connects AI system 250 to computer network 200. The network 200 may include multiple computing devices 104 in communication with each other and with other devices or components via one or more wired and/or wireless data communication links, where each communication link may comprise one or more of wires, routers, switches, transmitters, receivers, or the like. AI system 250 and network 200 may enable functionality, such as question/answer (QA) generation functionality, for one or more content users. Other embodiments of AI system 250 may be used with components, systems, sub-systems, and/or devices other than those that are depicted herein.

AI system 250 maintains corpus 260, also known as a “knowledge base,” which is a store of information or data that the AI system draws on to solve problems. This knowledge base includes underlying sets of facts, ground truths, assumptions, models, derived data, and rules which the AI system has available in order to solve problems. In one embodiment, a content creator creates content in corpus 260. This content may include any file, text, article, or source of data for use in AI system 250. Content users may access AI system 250 via a network connection or an Internet connection to the network 200, and, in one embodiment, may input questions to AI system 250 that may be answered by the content in the corpus of data. As further described below, when a process evaluates a given section of a document for semantic content, the process can use a variety of conventions to query it from the AI system.

AI system 250 may be configured to receive inputs from various sources. For example, AI system 250 may receive input from the network 200, a corpus of electronic documents or other data, a content creator, content users, and other possible sources of input. In one embodiment, some or all of the inputs to AI system 250 may be routed through the network 200. The various computing devices on the network 200 may include access points for content creators and content users. Some of the computing devices may include devices for a database storing the corpus of data. The network 200 may include local network connections and remote connections in various embodiments, such that AI system 250 may operate in environments of any size, including local and global, e.g., the Internet. Additionally, AI system 250 serves as a front-end system that can make available a variety of knowledge extracted from or represented in documents, network-accessible sources and/or structured data sources. In this manner, some processes populate the AI system with the AI system also including input interfaces to receive knowledge requests and respond accordingly.

AI Engine 270, such as a pipeline, is an interconnected and streamlined collection of operations. The information works its way into and through a machine learning system, from data collection to training models. During data collection, such as data ingestion, data is transported from multiple sources, such as sources found on the Internet, into a centralized database stored in corpus 260. The AI system can then access, analyze, and use the data stored in its corpus.

Models 275 are the result of AI modeling. AI modeling is the creation, training, and deployment of machine learning algorithms that emulate logical decision-making based on the data available in the corpus with the system sometimes utilizing additional data found outside the corpus. AI models 275 provide AI system 250 with the foundation to support advanced intelligence methodologies, such as real-time analytics, predictive analytics, and augmented analytics.

User interface 280, such as Natural Language (NL) Processing (NLP) is the interface provided between AI system 200 and human uses. Semantic content is content based on the relation between signifiers, such as words, phrases, signs, and symbols, and what they stand for, their denotation, or connotation. In other words, semantic content is content that interprets an expression, such as by using NLP. Semantic data is stored as part of corpus 260. In one embodiment, the process sends well-formed questions (e.g., natural language questions, etc.) to the AI system. AI system 250 may interpret the question and provide a response to the content user containing one or more answers to the question. In some embodiments, AI system 250 may provide a response to users in a ranked list of answers. Other types of user interfaces (UIs) can also be used with AI system 250, such as a command line interface, a menu-driven interface, a Graphical User Interface (GUI), a Touchscreen Graphical User Interface (Touchscreen GUI), and the like.

AI applications 290 are various types of AI-centric applications focused on one or more tasks, operations, or environments. Examples of different types of AI applications include search engines, recommendation systems, virtual assistants, language translators, facial recognition and image labeling systems, and question-answering (QA) systems.

In some illustrative embodiments, AI system 250 may be a question/answering (QA) system, which is augmented with the mechanisms of the illustrative embodiments described hereafter. A QA type of AI system 250 may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the I QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question.

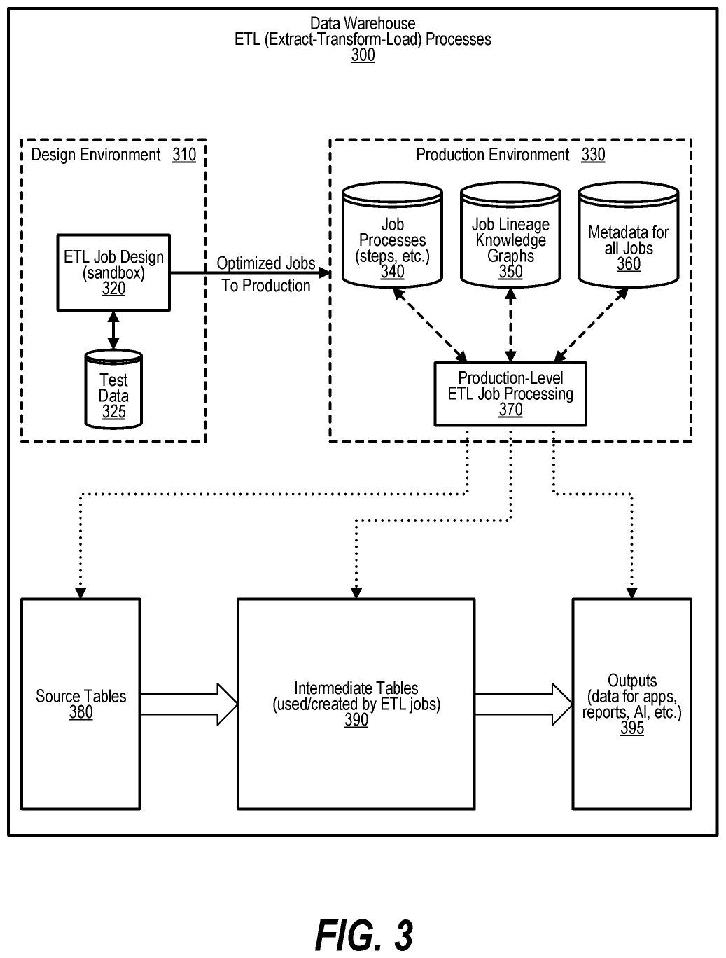

FIG. 3 is a component diagram depicting components used in designing ETL (Extract-Transform-Load) processes using a sandbox environment. Data warehouse 300 stores and processes the data of an organization using ETL processes. In the approach described herein, design environment is used to test new ETL jobs in a “sandbox” environment 320 using test data 325. Design environment is utilized to reduce or eliminate redundancy of ETL jobs and database files (e.g., tables, etc.) that are stored and run in the organization's data warehouse production environment 330.

After a new ETL job is tested and optimized (e.g., reducing redundancy, etc.) it can be migrated from design environment 310 to production environment 330. In the design environment, a new data lineage graph is created for the new ETL job that is being designed. The new data lineage graph created for the new ETL job is compared to existing data lineage graphs stored in data store 350. Each of the existing data lineage graphs correspond to an existing ETL job. These existing ETL jobs are stored in data store 340. In addition, metadata regarding ETL jobs is stored in data store 360. For example, one type of metadata can be parameters that determine whether a node (intermediate database file) in the job is “stale.” A given database file (e.g., table, etc.) can be used as an intermediate database file (node) for multiple ETL jobs. The metadata for each ETL job stored in data store 360 can be different for the same database file. For example, a “sales” database file can have a staleness parameter for use in a production (manufacturing) ETL job that is different than the staleness parameter used in a marketing ETL job.

Production-level ETL job process 370 runs the various ETL jobs from 340 utilizing metadata from data store 360 to determine whether intermediate database files are stale. If a database file, for a given ETL job, is deemed to be stale, then the process refreshes the intermediate database file (e.g., performs a particular SQL process, etc.) during the course of the ETL job. On the other hand, if the intermediate database table is deemed to be fresh for a particular job (not stale), then the data in the existing intermediate database file is used without having to refresh the database file.

Production-level ETL jobs read and process source tables 380 to create intermediate database files 390. These intermediate database files are used to create outputs that include a final database file generated by an ETL process that is often used to provide the data for applications, reports, artificial intelligence analysis, and the like, shown in Outputs box 395.

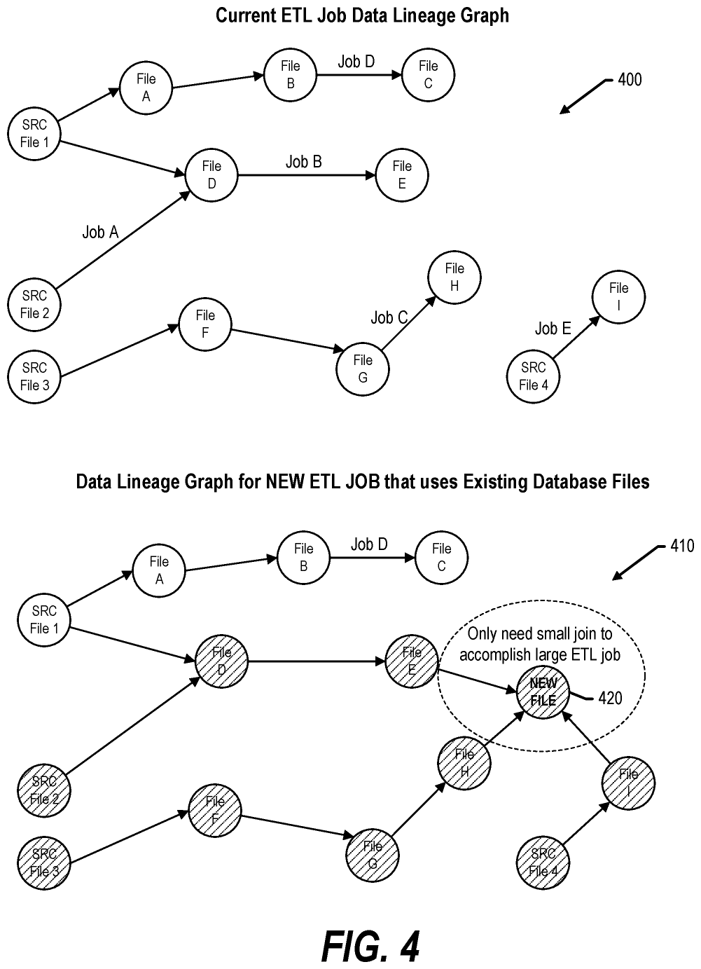

FIG. 4 is a current ETL job lineage knowledge graph and a knowledge graph for a new ETL job that uses existing intermediate tables. Data lineage graph 400 depicts an example data lineage graph before a new large ETL job is added to the system and data lineage graph 410 depicts the same graph after the new ETL job is added to the system (the development “sandbox” environment, etc.). The new ETL job is processed with the ETL job detailing the steps and data (intermediate files and final file 420 that results from the new ETL job. The circles represent “nodes” of the data lineage graph with the shaded circles shown in graph 410 being those nodes that are in the new data lineage graph that pertains to the new ETL job. Nodes might be source files (SRC Files 1 through 4) or intermediate/final nodes. Depending on the ETL job, a node might be an intermediate database file or a final database file for a particular ETL job.

Looking at the shaded nodes pertaining to the new ETL job, the new ETL job starts with source nodes 2, 3, and 4 (SRC File 2, SRC File 3, and SRC File 4). The intermediate nodes used by the new ETL job include database files D, E, F, G, H, and I. Processing of instructions included in the new ETL job (e.g., SQL statements, etc.) are used to generate the various intermediate database files and the final database file noted as NEW FILE 420.

Comparing the shaded nodes representing the new data lineage graph pertaining to the new ETL job with graph 400 depicting the data lineage graphs in existence at the data warehouse before the new ETL job was received results in discovery of the existing database files already being created and used by other ETL jobs and the additional database files that are needed to accomplish the new ETL job. In the example shown, only one join of database files E, H, and I is needed to create NEW FILE 420 that is generated by the new ETL job. The intermediate database files used to generate the new file (D, E, F, G, H, and I) are already in the system as they are each used as either intermediate files or as final files by other ETL jobs.

The new ETL job is modified to include pointers or references to the needed intermediate files that are already in the system. In one embodiment, references are also included for the ETL jobs that created such intermediate files so that the corresponding ETL jobs can be run if the intermediate database file is missing or stale. In addition, metadata regarding the freshness needed for each of these intermediate files is retained. In this manner, if an intermediate database file needed by the new ETL job already exists and its data is fresh (not stale), the intermediate file can be used as-is without any recreation by the new ETL job. On the other hand, if a needed intermediate database file is either missing or stale, then the intermediate database file can be created or refreshed. In one embodiment, the new ETL job retains instructions used to create/refresh the intermediate database files. In another embodiment, references to other ETL jobs that were used to create the intermediate database files are retains so that these other ETL jobs can be run to create/refresh the intermediate files needed by the new ETL job.

The new ETL job includes instructions (e.g., SQL “join” statements, etc.) used to create NEW FILE 420. As described above, if another (second) new ETL job uses NEW FILE 420 as an intermediate file, then this second new ETL job can utilize NEW FILE 420 as an intermediate file, while the same file was the final database file for the ETL job described in FIG. 4.

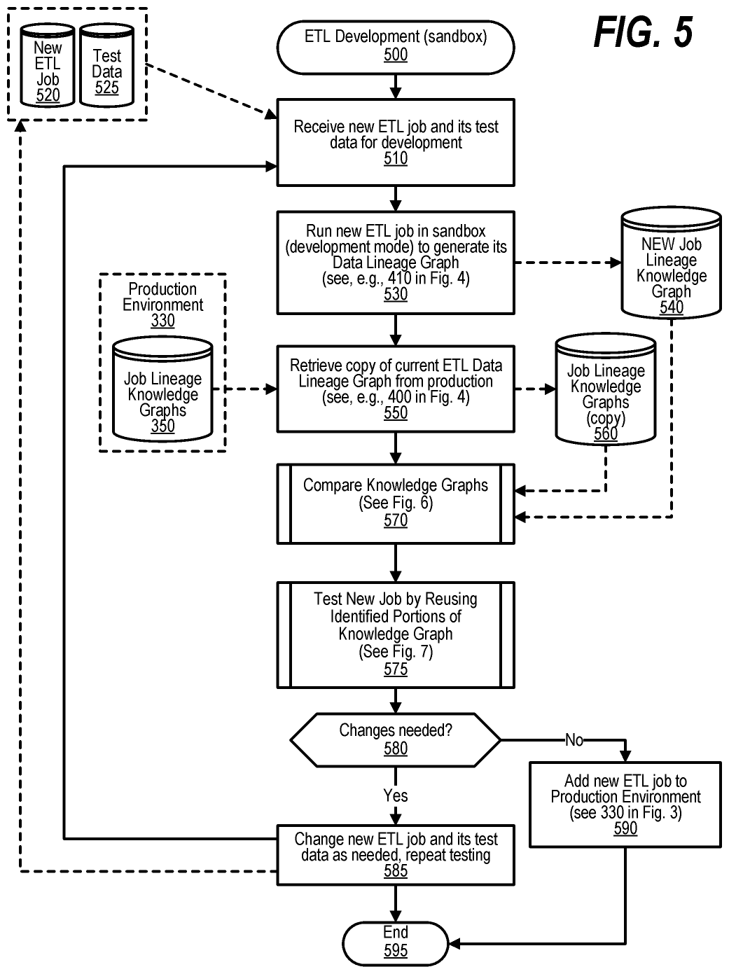

FIG. 5 is a flowchart depicting high-level steps used in an ETL development sandbox environment. FIG. 5 processing commences at 500 and shows the steps taken by a process that performs ETL New Job Development in a “sandbox” or test environment. At step 510, the process receives the new ETL job and its test data for development (data stores 520 and 525, respectively).

At step 530, the process runs the new ETL job in the sandbox environment (development mode) to generate its Data Lineage Graph (see, e.g., 410 in FIG. 4) which is stored in data store 540. At step 550, the process retrieves a copy of the current ETL Data Lineage Graphs from data store 350 with the graphs pertaining to the currently existing ETL jobs residing in the organization's production environment 330 (see, e.g., 400 in FIG. 4 for an example of such a data lineage graph). A copy of the production data lineage graph is stored in data store 560.

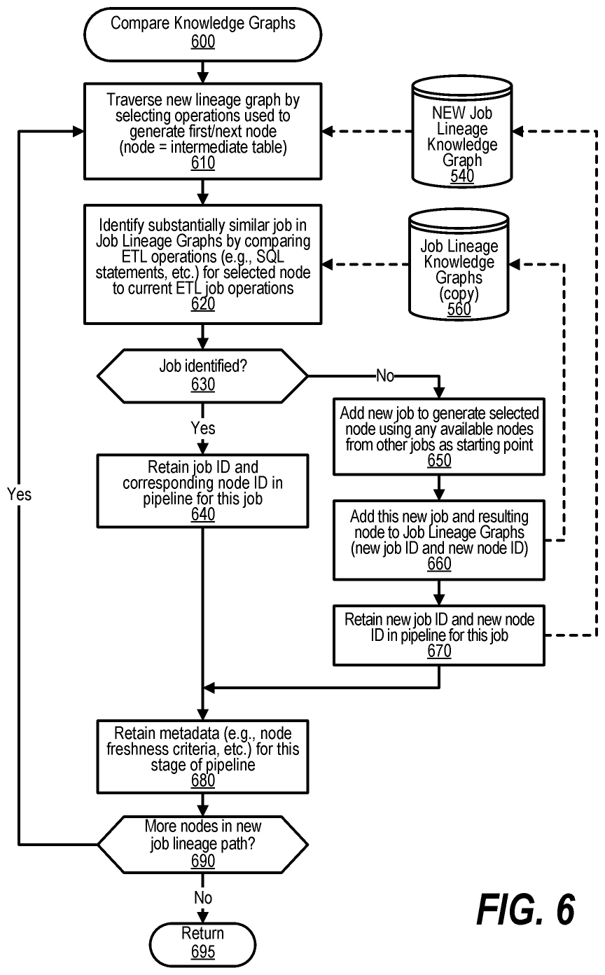

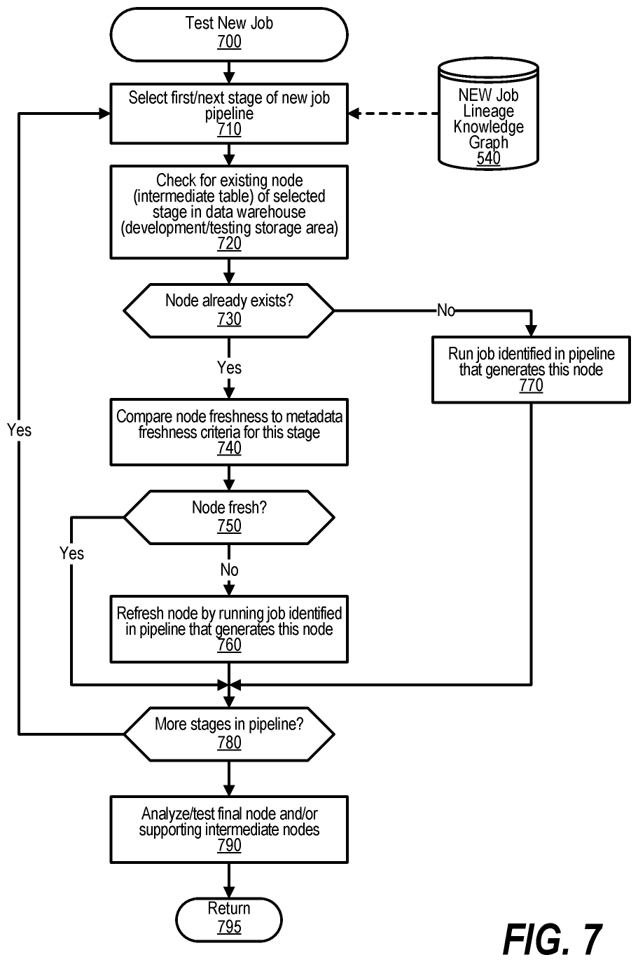

At predefined process 570, the process performs the Compare Knowledge Graphs routine (see FIG. 6 and corresponding text for processing details). At predefined process 575, the process performs the Test New Job by Reusing Identified Portions of Knowledge Graph routine (see FIG. 7 and corresponding text for processing details).

The process determines as to whether changes are needed to the new ETL job or if the job is ready for the production environment (decision 580). This decision might be made based on an analysis of the resulting database file or other final outputs of the new ETL job. If changes needed, then decision 580 branches to the ‘yes’ branch whereupon, at step 585, the process receives changes to the new ETL job and/or its test data and repeats the process by looping back to step 510. On the other hand, if no changes are needed to the new ETL job, then decision 580 branches to the ‘no’ branch whereupon, at step 590, at step 590, the process adds the new ETL job to the Production Environment (see 330 in FIG. 3). FIG. 5 processing thereafter ends at 595.

FIG. 6 is a flowchart depicting steps used to compare ETL knowledge graphs. FIG. 6 processing commences at 600 and shows the steps taken by a process that compares the data lineage graph corresponding to a new ETL job to data lineage graphs corresponding to already existing ETL jobs.

At step 610, the process traverses the new lineage graph by selecting the operations used to generate the first node from a source file (node=intermediate database file). The operations are those such as database commands, SQL statements, etc. At step 620, the process identifies any substantially similar job in Job Lineage Graphs by comparing the ETL operations (e.g., SQL statements, etc.) that were used to create the selected node and the current ETL job operations that are directed at creating the intermediate database file for the new ETL process.

The process determines as to whether an existing job was identified that already creates a substantially similar database file (decision 630). If an existing job was identified that already creates a substantially similar database file, then decision 630 branches to the ‘yes’ branch whereupon, at step 640, the process retains the job identifier of the existing ETL job and the corresponding node identifier corresponding to the database file created by the existing ETL job. The job ID and node ID are stored in the pipeline that is being created for this (new) job. On the other hand, if an existing job was not identified that already creates a substantially similar database file, then decision 630 branches to the ‘no’ branch to execute steps 650 through 670.

Steps 650 through 670 are performed when an existing ETL job was not found that creates a substantially similar database file as is needed by the new ETL job. At step 650, the process adds a new job that generates the selected intermediate node (database file) using any available nodes from other jobs as starting point. The new job includes the database commands (e.g., SQL statements, etc.) used to generate, or create, the database file. At step 660, the process adds this new job identifier and the resulting node identifier to the Data Lineage Graphs (new job ID and new node ID, see FIG. 4 for examples). At step 670, the process retains the new job ID and the new node ID in the pipeline for this job. At step 680, the process retains any metadata (e.g., node freshness criteria, etc.) for this stage of pipeline (e.g., the node (database file) that is used/created at this point in the pipeline, etc.).

The process determines as to whether there are more nodes to process in the new ETL job lineage path (decision 690). If there are more nodes in the new ETL job lineage path, then decision 690 branches to the ‘yes’ branch which loops back to step 610 to traverse the graph to generate the next node in the graph, as discussed above. This looping continues until there are no more nodes to process (e.g., after the final output database file is created for this ETL job, etc.), at which point decision 690 branches to the ‘no’ branch exiting the loop. FIG. 6 processing thereafter returns to the calling routine (see FIG. 5) at 695.

FIG. 7 is a flowchart depicting steps used to test a new job by reusing identified portions of the ETL knowledge graph. FIG. 7 processing commences at 700 and shows the steps taken by a process that tests a new ETL job in a development (sandbox) environment.

At step 710, the process selects the first stage of new job pipeline, such as creating an intermediate database file from a database source file. At step 720, the process checks for an existing node (the intermediate database file/table) of the selected stage already existing in the data warehouse (development/testing storage area).

The process determines whether the node (database file) already exists (decision 730). If the node (database file) already exists, then decision 730 branches to the ‘yes’ branch to perform steps 740 through 760. On the other hand, if the node does not already exist, then decision 730 branches to the ‘no’ branch whereupon, at step 770, the process runs job identified in pipeline that generates this node.

If the node (database file) already exists, the process performs steps 740 through 760. At step 740, the process compares the node (database file) freshness to the metadata freshness criteria for this stage in the ETL job pipeline. The process determines as to whether the comparison reveals that the node is fresh (decision 750). If the node is not fresh, then decision 750 branches to the ‘no’ branch whereupon, at step 760, the process refreshes the node by running the ETL job identified in pipeline that generates this node (database file). On the other hand, if the node is fresh, then decision 750 branches to the ‘yes’ branch bypassing step 760.

The process determines as to whether there are more stages in the ETL job pipeline to process (decision 780). If there are more stages in the ETL job pipeline to process, then decision 780 branches to the ‘yes’ branch which loops back to step 710 to select and test the next stage of the ETL pipeline as described above. This looping continues until all of the stages have been processed and tested, at which point decision 780 branches to the ‘no’ branch exiting the loop.

At step 790, the process analyzes and tests the final node (database file) and/or supporting intermediate nodes. This analysis and testing will determine whether the new ETL job is ready for the organization's production environment. FIG. 7 processing thereafter returns to the calling routine (see FIG. 5) at 795.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method comprising:
receive a new ETL job, wherein the job includes a plurality of intermediate database files descriptors corresponding to a plurality of intermediate database files that are used to accomplish the new ETL;
creating a new data lineage graph pertaining to the new ETL job;
comparing the new data lineage graph to a plurality of existing data lineage graphs, wherein each of the existing data lineage graphs correspond to one of a plurality of existing ETL jobs;
substituting one or more existing database files found in the existing data lineage graphs for one or more intermediate database files found in the new data lineage graph, the substituting based on similarities between the existing database files and the intermediate database files; and
running the new ETL job by utilizing the substituted database files, the result being a new final database file.

2. The method of claim 1 further comprising:
refreshing a set of one or more of the substituted database files in response to determining that the set of substituted database files contains stale data.

3. The method of claim 2 further comprising:
receiving a freshness parameter pertaining to the plurality of intermediate database files, wherein the determination of stale data is made by comparing the freshness parameters to one or more metadata corresponding to the set of substituted database files.

4. The method of claim 1 further comprising:
identifying one of the existing database files that contains the same data as the new final database file; and
informing a user of the new ETL job that the new final database file is redundant with the identified existing database file.

5. The method of claim 1 further comprising:
retrieving an identifier corresponding to each of the substituted existing database files and including the retrieved identifiers in the new ETL job.

6. The method of claim 1 wherein the running of the new ETL job tests the new ETL job, the method further comprising:
analyzing the new final database file; and
adjusting the new ETL job in response to the analysis revealing an error.

7. The method of claim 6 further comprising:
adding the new ETL job to a production environment in response to the analysis being successful.

8. An information handling system comprising:
one or more processors;
a memory coupled to at least one of the processors; and
a set of instructions stored in the memory and executed by at least one of the processors to perform actions comprising:
receive a new ETL job, wherein the job includes a plurality of intermediate database files descriptors corresponding to a plurality of intermediate database files that are used to accomplish the new ETL;
creating a new data lineage graph pertaining to the new ETL job;
comparing the new data lineage graph to a plurality of existing data lineage graphs, wherein each of the existing data lineage graphs correspond to one of a plurality of existing ETL jobs;
substituting one or more existing database files found in the existing data lineage graphs for one or more intermediate database files found in the new data lineage graph, the substituting based on similarities between the existing database files and the intermediate database files; and
running the new ETL job by utilizing the substituted database files, the result being a new final database file.

9. The information handling system of claim 8 wherein the actions further comprise:
refreshing a set of one or more of the substituted database files in response to determining that the set of substituted database files contains stale data.

10. The information handling system of claim 9 wherein the actions further comprise:
receiving a freshness parameter pertaining to the plurality of intermediate database files, wherein the determination of stale data is made by comparing the freshness parameters to one or more metadata corresponding to the set of substituted database files.

11. The information handling system of claim 8 wherein the actions further comprise:
identifying one of the existing database files that contains the same data as the new final database file; and
informing a user of the new ETL job that the new final database file is redundant with the identified existing database file.

12. The information handling system of claim 8 wherein the actions further comprise:
retrieving an identifier corresponding to each of the substituted existing database files and including the retrieved identifiers in the new ETL job.

13. The information handling system of claim 8 wherein the running of the new ETL job tests the new ETL job, the actions further comprising:
analyzing the new final database file; and
adjusting the new ETL job in response to the analysis revealing an error.

14. The information handling system of claim 13 wherein the actions further comprise:
adding the new ETL job to a production environment in response to the analysis being successful.

15. A computer program product comprising:
a computer readable storage medium comprising a set of computer instructions, the computer instructions effective to perform actions comprising:
receive a new ETL job, wherein the job includes a plurality of intermediate database files descriptors corresponding to a plurality of intermediate database files that are used to accomplish the new ETL;
creating a new data lineage graph pertaining to the new ETL job;
comparing the new data lineage graph to a plurality of existing data lineage graphs, wherein each of the existing data lineage graphs correspond to one of a plurality of existing ETL jobs;
substituting one or more existing database files found in the existing data lineage graphs for one or more intermediate database files found in the new data lineage graph, the substituting based on similarities between the existing database files and the intermediate database files; and
running the new ETL job by utilizing the substituted database files, the result being a new final database file.

16. The computer program product of claim 15 wherein the actions further comprise:
refreshing a set of one or more of the substituted database files in response to determining that the set of substituted database files contains stale data.

17. The computer program product of claim 16 wherein the actions further comprise:
receiving a freshness parameter pertaining to the plurality of intermediate database files, wherein the determination of stale data is made by comparing the freshness parameters to one or more metadata corresponding to the set of substituted database files.

18. The computer program product of claim 15 wherein the actions further comprise:
identifying one of the existing database files that contains the same data as the new final database file; and
informing a user of the new ETL job that the new final database file is redundant with the identified existing database file.

19. The computer program product of claim 15 wherein the actions further comprise:
retrieving an identifier corresponding to each of the substituted existing database files and including the retrieved identifiers in the new ETL job.

20. The computer program product of claim 15 wherein the running of the new ETL job tests the new ETL job, the actions further comprising:
analyzing the new final database file;
adjusting the new ETL job in response to the analysis revealing an error; and
adding the new ETL job to a production environment in response to the analysis being successful.
